(19) United States
(12) Patent Application Publication
(10) Pub. No.: US 2014/0106245 A1
(43) Pub. Date: Apr. 17, 2014

(54) METHODS FOR THE OPERATION OF A HUMIDIFICATION DEVICE FOR A FUEL CELL

(71) Applicant: MANN+HUMMEL GMBH, Ludwigsburg (DE)

(72) Inventors: Michael Harenbrock, Ludwigsburg (DE); Michael Fasold, Auenwald (DE); Steffen Schuetz, Bietigheim-Bissingen (DE); Stephan Niemeyer, Steinheim (DE)

(73) Assignee: MANN+HUMMEL GMBH, Ludwigsburg (DE)

(21) Appl. No.: 14/054,389

(22) Filed: Oct. 15, 2013

(30) Foreign Application Priority Data
Oct. 15, 2012 (DE) 102012020131.1

(51) Int. Cl. H01M 8/04

(52) U.S. Cl. CPC H01M 8/04126
USPC 429/414

(57) ABSTRACT

In a method for operating a humidifier for a fuel cell wherein the humidifier comprises a moisture exchanger with at least one water-permeable or water vapor-permeable membrane and a moisture reservoir, the moisture exchanger is flushed with flushing air and the flushing air is subsequently passed through the moisture reservoir.

### TECHNICAL FIELD

The invention concerns a method for operating a humidifier for a fuel cell.

### PRIOR ART

EP 1 261 992 B1 discloses a humidifier which is correlated with a fuel cell and by means of which an air stream that is supplied to the cathode of the fuel cell is enriched with moisture. The exhaust gas stream of the fuel cell which is laden with moisture is supplied to the humidifier which has a water vapor-permeable membrane through which the moisture is transferred to the fresh air stream to be supplied to the fuel cell.

### SUMMARY OF THE INVENTION

The invention has the object to ensure under various operating conditions a proper function of a humidifier which is correlated with a fuel cell.

This object is solved according to the invention with the features of claim 1. The dependent claims provide expedient further developments.

The invention concerns an operating method of a humidifier for a fuel cell whose cathode is supplied with a fresh air stream which is enriched with moisture in the humidifier. The humidifier has for this purpose a moisture exchanger with at least one water-permeable or water vapor-permeable membrane which is positioned between an inlet air flow path and an exhaust air flow path and through which the moisture of the exhaust air flow path of the fuel cell is transferred onto the inlet air flow path.

The humidifier has in addition to the moisture exchanger also a moisture reservoir that is positioned in a flow path of the humidifier and is capable of releasing moisture into the flow path or to absorb moisture from the latter. The humidifier represents a moisture buffer by means of which the moisture contents in the flow path can be regulated. It is in particular possible to increase by means of the moisture reservoir the moisture contents in the flow path and to adjust it in this way to a minimum value or nominal value which is required for proper functioning of the fuel cell. In reverse, it is also possible to utilize moisture-laden air for regeneration of the moisture reservoir. The moisture reservoir enables a broader application range of the humidifier.

In the method for operating the humidifier, the moisture exchanger is flushed in certain operating states with flushing air and the flushing air subsequently is passed through the moisture reservoir. Flushing of the moisture exchanger transports the still present residual moisture away from the humidifier so that in particular after switching off the fuel cell the remaining moisture contents in the humidifier is significantly reduced and the risk of damage by means of the remaining residual moisture is reduced. Accordingly, the flushing process is advantageously performed after the fuel cell has been switched off. The reduced moisture contents in the humidifier reduces the risk of frost-caused damage of the membrane in the moisture exchanger.

The flushing air is passed downstream of the moisture exchanger through the moisture reservoir in which the moisture is absorbed in the moisture reservoir medium. In this way, the moisture reservoir medium is regenerated and, in a subsequent operating cycle, can release its moisture into the inlet air flow path to the fuel cell. Accordingly, by means of the flushing process which is performed subsequent to switching off the fuel cell, an additional advantage is achieved, namely, regeneration and charging of the reservoir medium in the moisture reservoir with moisture.

As a moisture reservoir medium preferably a superabsorbent material is used which is capable of absorbing and binding moisture in an amount multiple times its own weight. The superabsorbent material has also the advantage that lowering of the freezing point and thus a release in the form of gas molecules into the air stream even under frost conditions are possible. As a superabsorbent material, a superabsorbent polymer (SAP) is conceivable, for example, which is constructed of hydrophilic polymer fibers that can absorb water and swell in doing so. The superabsorbent polymer can also be embodied in the form of beads. Upon absorption of the water a reversible absorption of the material occurs that in this way embeds the water. Upon desorption the water is released again. The hydrophilic fibers can optionally be embedded in a nonwoven support.

The flushing process of the moisture exchanger is realized expediently via the inlet air flow path which extends through the moisture exchanger. The moisture exchanger can have correlated therewith a pressure source, for example, a pump or a turbocharger which drives the air within the flow path. In this way, it is in particular possible to drive the flushing air by the pressure source, even after switching off the fuel cell, and pass it through the moisture exchanger as well as subsequently through the moisture reservoir.

Expediently, the flushing air after having passed through the moisture reservoir is discharged into the environment. Therefore, by means of the moisture reservoir two different flow paths are available, i.e., on the one hand the inlet air flow path that extends downstream of the moisture reservoir to the cathode of the fuel cell and on the other hand, as a further additional flow path, a flushing flow path that crosses, for example, the inlet air flow path and, downstream of the moisture reservoir, opens into the environment. For the flushing process, the flushing flow path is selected wherein switching between the inlet air flow path and the flushing flow path is advantageously performed by switching valves which are arranged in the inlet air flow path or in the flushing flow path. The configuration with the two separately embodied flow paths through the moisture reservoir and the switching valves has the advantage that a precise operating state-dependent control of the flushing process in the moisture exchanger is possible.

### BRIEF DESCRIPTION OF THE DRAWINGS

Further advantages and expedient embodiments can be taken from the additional claims, the figure description, and the drawings. It is shown in:

FIG. 1 in schematic illustration a humidifier for a fuel cell, comprising a moisture exchanger that contains a water-permeable membrane that is subjected crosswise to an inlet air flow and an exhaust air flow;

FIG. 2 a humidifier for a fuel cell, comprising a moisture exchanger and a moisture reservoir.

In the figures same components are identified with same reference characters.

### EMBODIMENT(S) OF THE INVENTION

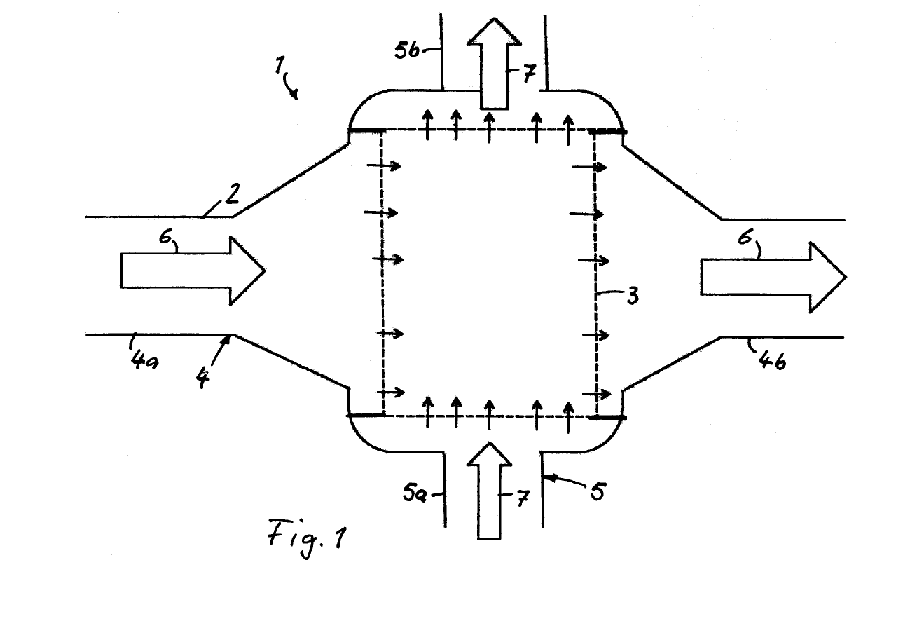

Via the humidifier 1 that is schematically illustrated in FIG. 1 a fuel cell is supplied with fresh air that is enriched with moisture and has a minimum moisture contents. The humidifier 1 comprises a cartridge 3 which is fixedly or exchangeably received in a housing 2 and which transfers moisture contained in an exhaust gas stream onto a dry fresh air stream which is supplied to the fuel cell. The cartridge 3 has at least one, preferably several, stacked water-permeable membranes.

Via a fresh air passage 4 in the housing 2 the humidifier 1 is supplied with ambient air as fresh air. The fresh air passage 4 has a supply section 4a upstream of the cartridge 3 as well as a discharge section 4b downstream of the cartridge.

In the housing 2, at a 90 degree angle relative to the fresh air passage 4 an exhaust gas passage 5 is extending through which exhaust gases of the fuel cell which are enriched with moisture are passed through the cartridge. The exhaust gas passage 5 has a supply section 5a upstream of the cartridge 3 and a discharge section 5b downstream of the cartridge.

A fresh air stream 6 is passed via the fresh air passage 4 through the humidifier 1, the exhaust gas stream 7 originating from the fuel cell via the crossing exhaust gas passage 5. The crossing streams 6 and 7 are separated within the cartridge 3 by the water-permeable membrane which permits only water exchange from the exhaust gas stream 7 laden with high moisture onto the dry fresh air stream 6. The fresh air passage 4 forms the inlet air flow path for supply of fresh air enriched with moisture to the fuel cell, the exhaust gas passage 5 the exhaust air flow path.

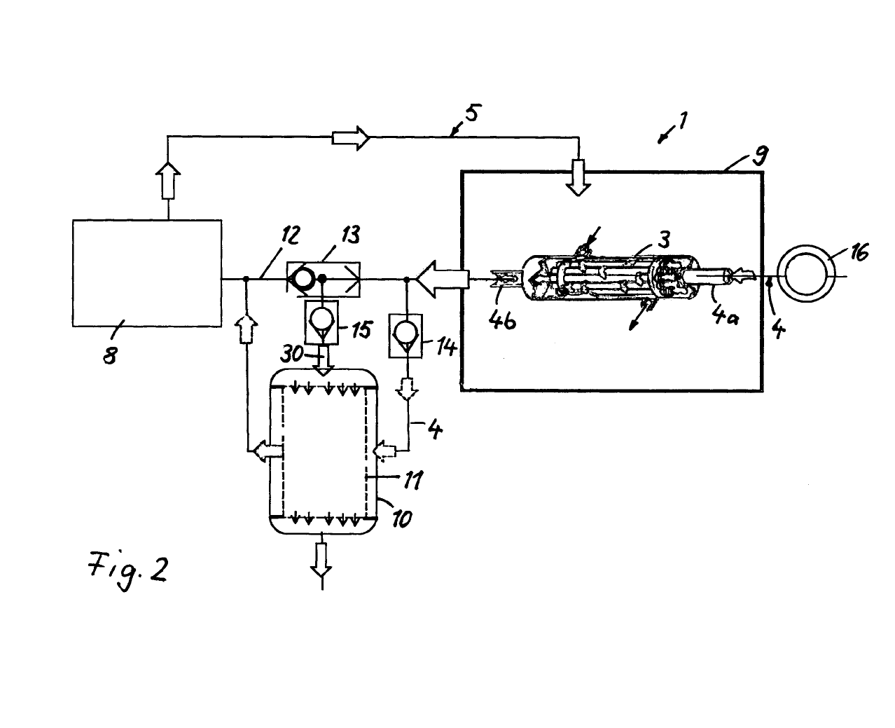

In FIG. 2 a humidifier 1 for a fuel cell 8 is illustrated. The humidifier 1 comprises a moisture exchanger 9 that serves for enriching the inlet air flow path 4 to the fuel cell 8 with moisture which is originating from the exhaust air flow path 5 which transports exhaust gas away from the fuel cell 8. The humidifier 1 comprises moreover a moisture reservoir 10 in which a moisture reservoir medium 11 is received, preferably a superabsorbent element or superabsorbent polymer (SAP). The moisture exchanger 9 and the moisture reservoir 10 that together form the humidifier 1 are arranged so as to be separated spatially and are positioned in the inlet air flow path 4 behind each other. The two units can optionally be arranged in a common housing. The moisture reservoir 10 is downstream of the moisture exchanger 9 within the inlet airflow path 4.

The cartridge 3 with one or several membranes for water exchange is arranged in the moisture exchanger 9. The membranes are provided, for example, as hollow fibers that are flowed through axially in longitudinal direction by dry fresh air via the inlet air flow path 4 and, in transverse direction, are subjected to flow of the moisture-laden exhaust air of the fuel cell 8 in the exhaust air flow path 5. The moisture from the exhaust air is transferred via the membranes onto the fresh air stream. After the moisture exchange, the exhaust air is discharged from the moisture exchanger 9 into the environment.

In the inlet air flow path 4 there is between the moisture exchanger 9 and the fuel cell 8 a bypass with a bypass line 12 and a switching valve 13 arranged therein. The bypass line 12 bypasses the moisture reservoir 10 so that in certain operating states the moisture reservoir 10 can be bypassed. Moreover, in a branch line which is extending through the moisture reservoir 10 and extends farther to the cathode side of the fuel cell 8, an adjustable switching valve 14 is arranged. A further switching valve 15 is arranged between the switching valve 13 and the moisture reservoir 10 in a flushing flow path 30 which is extending through the moisture reservoir 10 and opens into the environment; the flushing flow path 30 crosses the inlet air flow path 4 through the moisture reservoir 10 that extends downstream of the moisture reservoir 10 to the cathode of the fuel cell 8. With the bypass line 12 and the different switching valves 13 to 15, different operating modes in different operating states can be realized.

During the start phase, in particular at low temperatures, the moisture contents in the exhaust air of the fuel cell 8 that is passed via the exhaust air flow path 5 to the moisture exchanger 9 is insufficient. In order to provide at the cathode of the fuel cell 8 a sufficient moisture contents in the supplied fresh air stream, in the start phase of the fuel cell the cathode air stream is partially or completely passed through the moisture reservoir 10 with the moisture reservoir medium 11. For this purpose, the switching valve 14 is opened, the switching valve 13 is closed in the flow direction to the fuel cell 8. Inasmuch as a partial air stream is to be passed also immediately through the bypass line 12, the switching valve 13 can be moved into a partially open position.

In the normal operating state of the fuel cell 8 that follows the start phase, at the exhaust air side a sufficient moisture contents is available that passes through the exhaust air flow path 5 to the moisture exchanger 9 and is transferred thereat to the inlet air flow path 4. As a result of the higher moisture contents in the inlet air, the moisture reservoir 10 can be bypassed so that the inlet air to the cathode is supplied immediately via the bypass line 12. The switching valve 14 is moved into the closed position, the switching valve 13 is opened. The switching valve 15, which is arranged between the bypass line 12 and immediately the moisture reservoir 10, is in the closed position.

In order to discharge the moisture from the moisture exchanger 9 after switching off the fuel cell 8, the inlet air stream is guided to the exterior via the inlet air flow path 4 and the flushing flow path 30 branching off the inlet air flow path 4 during a flushing process after switching off. Upstream of the moisture exchanger 9 in the inlet air flow path 4 a pressure source 16 is provided which pressurizes the inlet air in the flow path 4 and drives it. In this way, even after switching off the fuel cell 8, it is ensured that a flow in the inlet air flow path 4 is generated and the still existing residual moisture in the moisture exchanger 9 can be passed via the open switching valve 13 and the flushing flow path 30 with the switching valve 15 that is also open through the moisture reservoir 10 and subsequently discharged to the exterior. In the moisture reservoir 10 the residual moisture contained in the inlet air stream is stored in the moisture reservoir medium 11 which is regenerated and therefore charged again with moisture in this way. The switching valve 14 can remain closed in this operating phase.

The pressure source 16 which is, for example, a pump or a turbocharger can optionally also be switched on in the start phase and in the regular operating phase in order to ensure an air stream in the direction of the cathode of the fuel cell 8.

1-11. (canceled)

12. A method for operating a humidifier connected to a fuel cell, comprising:
a humidifier including
a moisture exchanger with at least one water-permeable or water vapor-permeable membrane that separates an inlet air flow path from an exhaust air flow path;
the method comprising:
disposing a moisture reservoir in a flow path of a moisture exchanger;
flushing the moisture exchanger with flushing air; and then
passing the flushing air through the moisture reservoir.

13. The method according to claim 12, wherein
in the flushing step, flushing is carried out after switching off the fuel cell.

14. The method according to claim 12, further comprising
supplying the flushing air via the inlet air flow path.

15. The method according to claim 12, further comprising
driving the flushing air with a pressure source.

16. The method according to claim 12, further comprising
discharging the flushing air into the environment after the step of passing through the moisture reservoir.

17. A humidifier for performing the method according to claim 12, the humidifier comprising
a moisture exchanger with at least one water-permeable or water vapor-permeable membrane that separates an inlet air flow path of the humidifier from an exhaust air flow path of the humidifier;
a moisture reservoir arranged downstream in a flow path of the moisture exchanger.

18. The humidifier according to claim 17, further comprising
a pressure source disposed in the inlet air flow path generating an inlet air stream through the humidifier.

19. The humidifier according to claim 18, wherein
the pressure source is arranged upstream of the moisture exchanger.

20. The humidifier according to claim 17, wherein
the moisture reservoir contains a superabsorbent material as a moisture reservoir medium.

21. The humidifier according to claim 17, wherein
the inlet air flow path is passes through the moisture reservoir;
wherein the moisture reservoir is arranged downstream of the moisture exchanger;
wherein the air flow path extends further to a fuel cell;
wherein a flushing flow path passing through the moisture reservoir branches off the inlet air flow path;
wherein the flushing flow path opens into the environment downstream of the moisture reservoir.

22. The humidifier according to claim 21, comprising
switching valves arranged in the inlet air flow path and in the flushing flow path.
